(19) United States
(12) Patent Application Publication
(10) Pub. No.: US 2009/0144374 A1
(43) Pub. Date: Jun. 4, 2009

(54) System and Method for Unsolicited Electronic Mail Identification and Evasion

(76) Inventor: Gant Laborde, New Orleans, LA (US)

Correspondence Address: ANDREW G. VICKNAIR;Shields Mott Lund, LLP, 650 POYDRAS STREET, Suite 2600, NEW ORLEANS, LA, 70130, US

(21) Appl. No.: 11/948,649

(22) Filed: Nov. 30, 2007

(51) Int. Cl. G06F 15/16

(52) U.S. Cl. 709/206

(57) ABSTRACT

A method and system are disclosed for the identification of and avoidance of unsolicited email or Spam mail. The present invention is a system and method for channeling email to prevent unsolicited email and to identify the sources of unsolicited email by creating a new layer to a common email exchange. The present invention is not spam filtering, though it can be used in conjunction with spam filters to increase the effectiveness of such filters. The present invention may work off of a client and server methodology to keep email identifiable through select channels that are agreed upon with the client and server. The present invention is not dependent upon specific operating systems or implementations of an email protocol. The present invention may be comprised of multiple configuration settings that may ask, allow, deny, and remember implementation level features.

### TECHNICAL FIELD

The present invention relates, in general to electronic mail operations, methods and systems, and more specifically to anti-spam methods and systems that can identify spam sources and protect/prevent electronic mail users from receiving unsolicited electronic mail, along with providing users with additional control over electronic mail systems.

### BACKGROUND OF INVENTION

Spam or spam mail is known as junk e-mail, unsolicited e-mail, often of a commercial nature, sent indiscriminately to multiple mailing lists, individuals, or newsgroups. Electronic mail users and systems have been plagued with, bothered by, and continue to deal with spam. The existence of spam leads to many problems and often costs electronic mail users, such as corporations, government entities, and the like valuable time and money. Time and money is continuously used by various e-mail users that want to block or prevent spam from reaching e-mail accounts. Spam affects corporations, governments and civilians worldwide, and often transgresses legal and ethical guidelines. As the world progresses, e-mail accounts are increasing in popularity and are essential to daily matters both personal and business related.

Unfortunately, spamming is a commercial industry. For example, there are companies that will spam several e-mail addresses for a fee and there are guides that will inform you how to create and carry out the act of spamming several e-mail addresses. A major problem with spam is that it actually works. Surveys and studies reveal that sales of products and services actually result from spam. If spamming did not work, then spamming and spam would have died down over the years. However, spam is one of the most cost effective methods of advertising to large groups of individuals, through e-mail accounts. Because spam actually works and it is costs effective, spamming and spam continues to grow every day.

Spam has become such a problem and nuisance to its unsolicited recipients that legislation has passed in various countries that aims to stop unsolicited email. Yet, many types of spam do not break any of the anti-spam laws. Thus, spamming and spam will likely continue to grow until additional legislation is passed that further restricts spam and clearly defines the penalties for violators. Another problem with preventing spamming and spam is that in countries where freedom of speech is clearly allowed, restricting Internet access and preventing all spam may be seen as a violation of the freedom of speech.

Spammers, or individuals or entities that generate spam, are constantly causing problems, complications and may violate anti-spam regulations and laws. In fact, spam has caused such problems that law suites have been filed against spam companies for violating the various anti-spam legislation, where damages have been assessed at approximately 1 billion dollars. Spam is a serious problem that affects a majority of all e-mail users. In fact, some statistics gathered from various sources, such as Google, Brightmail, Jupiter Research, eMarketer, Gartner, MailShell, Harris Interactive, and Ferris Research, have indicated that in 2006 (a) forty percent (40%) of all e-mail was spam, (b) over 12.4 billion spam e-mails were sent each day, (c) over two hundred fifty-five ($255,000,000.00) million dollars was spent dealing with spam costs for all non-corporate Internet users, (d) over 26 states in the United States have enacted anti-spam laws, (e) sixteen percent (16%) of e-mail changes were due to spam, and (f) an average of 4 to 5 seconds per spam e-mail of corporate time was wasted in dealing with spam. Spam and spamming is a real problem, and as the Internet world continues to expand, e-mail continues to be an essential part of conducting business. The numerous problems associated with and generated by spam, such as the amount of time and money spent dealing with and preventing spam, is unacceptable and solutions are needed to address said problems.

Typical email communications may operate as shown in FIG. 1. FIG. 1 illustrates email user 100, communication link 105, email service 110, communication links 115, and email user 120. Typically, when an email user, such as email user 120 with email address A wishes to send an email to a recipient, such as email user 100 with email address B, the email user will compose an email addressed to that recipient. A user will then send the email through some type of email service and/or communication link, such as communication link 115, that may transfer the email message to the user's email service, such as email service 110. Email service 110 may then process the email and send the email to the intended recipient through some type of communication link, such as communication link 105, so that the message will be delivered to the recipient, such as email user 100. This illustration is very basic, and as illustrated, the email from user A is sent to user B with no filtration or monitoring for unsolicited mail. Thus, in this type of system email users are often bombarded with unsolicited email over and over.

Accordingly, a need exists in the art for an anti-spam system and method that allows users to identify, and isolate unsolicited e-mails and spam, and alert e-mail service providers of the sources of spam. Such an anti-spam method and system may work with current anti-spam technology and can become a beneficial system and method that may enhance e-mail communications by preventing and isolating spam.

### BRIEF SUMMARY OF THE INVENTION

The present invention is directed to a system and method for spam protection and identification. The system and method may comprise a client and/or server software. The client and server software portions may be married in the way that their communication is considered secure and that a user can have the method and system configured to comply with their needs. The client portion of the present invention may be configured to monitor at any layer, such as any of the layers of the OSI Reference Model of computer network architecture including, but not limited to, the application layer, presentation layer, session layer, transport layer, network layer, data link layer, and the physical layer. Depending on the type of configuration, the client portion may also interact with various user activities. For example, the client portion of the present invention may interact with a user based on the user's intranet and Internet traffic at a desired protocol communication layer.

The server component of the present invention may be a server software portion running on a server system or it may be configured as a method running on a workstation and/or computer in any number of configurations. In addition, the server component may be interactive with any number of other programs or methods currently running on a user's workstation, such as being interactive with the client's e-mail server. However, the server component is not limited to being interactive with the client's e-mail server. The server component of the present invention may be configured as software running on an independent machine and may even be transparent to the current e-mail service or software running on the machine.

In one embodiment, the client portion may run on a user's computer/workstation and may be configured to capture and identify a user's original outgoing email address along with other data, such as environment data associated with the email that may consist of the outgoing email address, the recipient email address, a time stamp, a date stamp, any header information, incoming IP addresses, outgoing IP addresses, and the like. Environment data may be recorded to help identify and distinguish the source of an email that a user did solicit from the source of an email that a user did not solicit. After the client portion has captured a user's original outgoing email address, the client portion may communicate with the server portion. In communicating with the server portion, the client portion may request the server portion to generate a unique identifier, such as a new unique email address. This unique identifier, such as a new unique email address, may then be used in the place of the user's original outgoing email address so that the unique identifier/unique email address may be used as the email address passed on to outside locations and environments. Thus, when a user chooses to send emails, the party receiving the email is not given the user's original email address because the unique identifier/email address may be used in the place of the user's original email address.

Depending on the configuration, the server portion may store any captured environment data or the captured environment data may be stored by the client portion. The server portion may also be configured to filter and process incoming emails based on any number of rules, such as user defined rules, or various levels of pre-defined rules. Depending on the rules and filters, the server and/or client may pass incoming emails on to the user's direct email, delete the incoming emails and only send partial data to the user's direct email about the deleted incoming email, and/or delete all data associated with an incoming email.

The server portion may manage the unique identifier, such as the new unique email address, and may have a set of rules for the server portion to operate as a “Channel” to the user's email system. If the “Channel” is open, without restriction, then an incoming email is passed along to the user in a seamless fashion. However, if there is a rule or filter set up on the “Channel,” then that rule or filter will be acted upon and may prevent incoming email from reaching the user. For example, if a rule is set-up to prevent all incoming email that does not match up with environment data that was previously stored to identify a solicited source, and an incoming email is delivered from an unsolicited source, then the “Channel” or unique email address that the unsolicited source is sending email to may be shut off so that all emails from the unsolicited source will not be delivered and/or passed on to the user. This implementation of the rule and/or filter allows for “Channel-specific” rule and filtering.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of a basic email system;

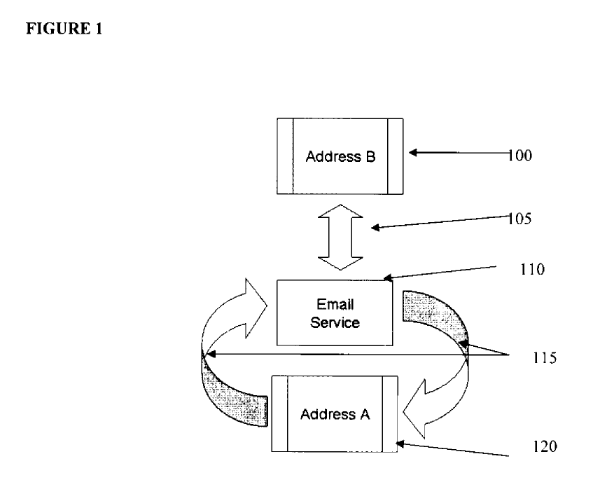

FIG. 2A is an illustration of a general architecture of a system of one embodiment of the present invention

FIG. 2B is an illustration of an operation of one embodiment of the present invention implemented through the general architecture illustrated in FIG. 2A;

FIG. 3 illustrates a block diagram of another sample operation of the present invention;

FIG. 4 is a block diagram illustrating a use of the present invention to channel incoming email; and

FIG. 5 depicts a block diagram of a computer system which is adapted to use an embodiment of the present invention.

### DETAILED DESCRIPTION OF THE INVENTION

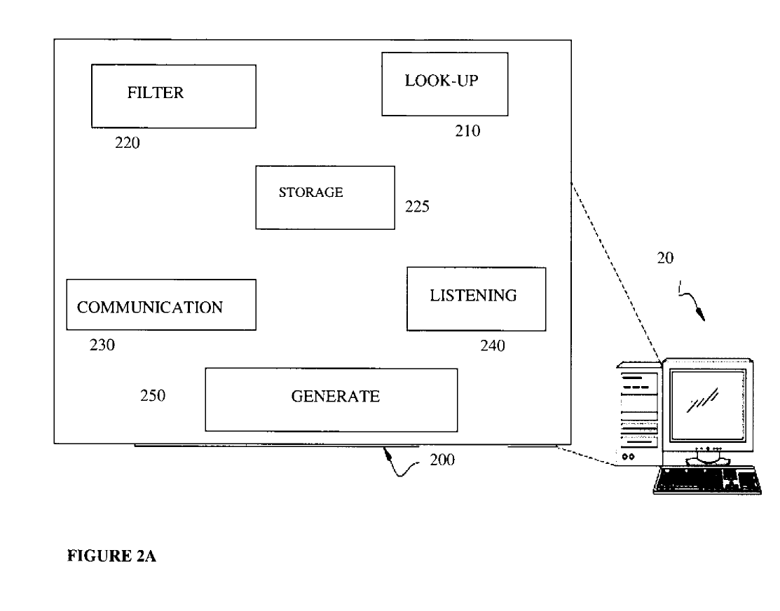

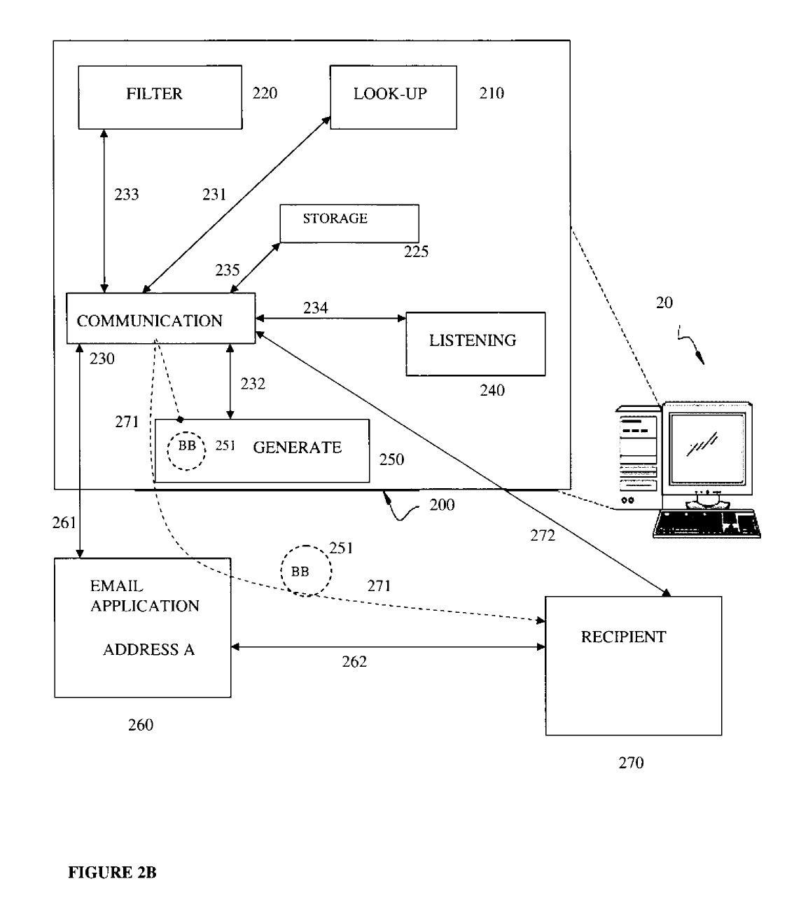

FIG. 2A is a diagram illustrating unsolicited email identification and prevention environment 200 implemented on computer 20 for identifying and preventing unsolicited email and/or spam according to one embodiment of the present invention. The present invention may be configured to prevent and/or identify unsolicited email and/or spam through the use of channeling and/or filtering of email messages. The present invention may generate unique email addresses to be used in place of an original email address whereby each unique email address will act as a channel to an end user. If a unique email address is shut off and/or filtered then the channel to an end user associated with the unique email address will be closed thereby preventing email that is addressed to the unique email address form reaching the end user. The channeling and/or filtering may be configured based on a set of user specific rules that are identified by each individual user or based on generic levels of implementation, such as minimum application, medium application, maximum application and the like. After the channeling and/or filtering is configured, a server and/or client portion of the present invention may act upon the channeling and/or filtering rules and may prevent incoming email from reaching the user. In addition to unsolicited email identification and prevention environment 200, the computer system may include an operating system, a computer's coordinating program that is built on the instruction set for a processor or microprocessor, and the hardware that performs the logic operations and manages the data movement of the computer.

Unsolicited email identification and prevention environment 200 represents one application running on computer 20. In one embodiment of the present invention, unsolicited email identification and prevention environment 200 includes look-up module 210, filter module 220, storage module 225, communication module 230, listening module 240, and generate module 250. Unsolicited email identification and prevention environment 200 is advantageous as it may be used to completely prevent spam mail from reaching a user's email address and/or account. The present invention may be configured by a user to prevent all spam from one particular source while allowing various other email messages from any number of other sources to pass through to a user. While the present invention can prevent an actual spam message from being delivered to a user's email, the present invention may be configured to provide the user with other data associated with the blocked spam message, such as the spammer's IP address, the spammer's email address, how the spammer obtained the user's email address, and the like. This information provided by the present invention about the spam message is useful as it may then be used for additional filtering/spam blocking purposes. For example, system administrators could gather and compile information about spamming sources provided by the present invention from various spam messages and then identify the compiled information as a list of what may be considered spam. This compiled information/list may also be shared through a universal source for overall spam filtering so that individuals can see if others have also marked a particular source as spam or can view the spam sources list as an additional means of preventing spam mail.

Unsolicited email identification and prevention environment 200 may be configured so that email addresses that are to be governed and analyzed by the present invention may be registered and/or placed on a list of email addresses that are to be processed and/or governed by the present invention. Look-up module 210 may be configured to analyze a user's email address to determine if a particular user's email address is an email address that is to be analyzed and/or monitored by the present invention. In short, look-up module 210 is basically checking to determine if a user's email address is to be monitored by the present invention. If look-up module 210 checks a user's email address and determines that the email address is not to be analyzed and/or monitored by the present invention until further notice, then that user's email address will not be analyzed and/or monitored by the present invention and the present invention will not analyze, monitor, and/or filter email activity of that user and will not prevent any messages from reaching that user's email address. If look-up module 210 checks a user's email address and determines that the user's email address is to be monitored by the present invention, then look-up module 210 may mark and/or code the user's email address so that the present invention will continue to monitor the user's email address as long as that user's email address is identified as an email address to be governed by the present invention. In alternative embodiments, look-up module 210 may be configured to ask a user if he/she would like to implement the present invention so that the user's email address will be monitored by the present invention. If a user were to respond and indicate that he/she would like to implement the present invention to monitor his/her email communications, the present invention may then mark and/or code any email addresses identified by the user as email addresses to be monitored by the present invention. Look-up module 210 is advantageous as it allows users to configure the present invention so that a user can choose which email addresses will be monitored by the present invention and which email addresses will not be monitored by the present invention. The present invention may also be configured so that look-up module 210 will have no effect upon and will not interfere with any other software methods running on a client and/or server.

In one embodiment of the present invention, filter module 220 may be configured to filter and/or evaluate incoming emails based on any number of rules, such as user specific and configured rules or any number of pre-set and pre-configured baseline rules. The present invention may also be configured so that any pre-set and/or pre-configured rules may be activated or inactivated by a user. In a preferred embodiment, the present invention is configured so that a user may create and implement his/her own rules depending on any number of circumstances. For example, a user may configure the present invention with a set of rules such that when those rules are activated, the present invention may filter out and/or prevent all emails coming from a specific IP address and/or a range of IP addresses, prevent all emails originating from a specific domain and/or list of domains, prevent all emails that are coming from an unsolicited source, prevent all emails based on content, prevent all incoming emails that were addressed to a new unique email address or specific channel generated by the present invention by modifying, altering, shutting off or closing the specific channel or new unique email address, prevent all emails based on email header content information, only allow emails originating from a specific domain or list of domains, only allow emails originating from a specific IP address or list of IP addresses, only allow emails based on certain content, and the like. The list above is not a limitation of the present invention, but merely an example of how the present invention may be configured. Furthermore, an embodiment of the present invention is not limited to simply preventing or allowing emails to be delivered and/or channeled to a user, but the present invention may be configured so that depending on the set of rules activated, the present invention may perform any number of functions for an incoming email, such as move an email to a specific folder, forward the email to a different email address, automatically respond to the email, and the like.

The present invention may also be configured to include storage module 225. Storage module 225 may be configured as a general input/output storage module that stores any type of data to be used by the present invention, such as any data used and/or needed by the various modules of unsolicited email identification and prevention environment 200. For example, storage module 225 may store (1) a list of all email addresses that have been identified as email addresses that are to be monitored by the present invention, (2) a list of all email addresses that have been identified as not to be monitored by the present invention, (3) the various rules used by filter module 220 in filtering and/or evaluating incoming email messages, (4) all environment data associated with incoming and outgoing email activity, and the like. The list above is not a limitation of the present invention, but merely an example of how the present invention may be configured. With storage module 225 storing various data, such as the filtering rules, the present invention may be configured so that when filter module 220 is filtering and/or evaluating email messages, filter module 220 will obtain the various rules to be used in filtering and/or evaluating incoming email messages from storage module 225. Likewise, when look-up module 210 analyzes/checks an email address to determine if it is to be governed by the present invention, look-up module 210 may compare that currently analyzed email address against a list of email addresses stored in storage module 225, which were previously identified as email addresses to be governed by the present invention, to determine if the currently analyzed email address is to be governed by the present invention.

Although FIG. 2A illustrates storage module 225 as part of unsolicited email identification and prevention environment 200, the present invention is not limited to this configuration. In alternative embodiments of the present invention, storage module 225 may not be part of unsolicited email identification and prevention environment 200. For example, in one embodiment, storage module 225 may be a general storage module that runs on a separate machine as storage for any number of applications and processes. In other embodiments, storage module 225 may be a sub-module that is part of every module, including, but not limited to, filter module 220, look-up module 210, communication module 230, listening module 240, and generate module 250.

Communication module 230 handles communication among and between the various modules within unsolicited email identification and prevention environment 200 and may also handle communications outside of unsolicited email identification and prevention environment 200. For example, communication module 230 may communicate data including, but not limited to, a user's email address from communication module 230 to listening module 240, from listening module 240 to look-up module 210, from look-up module 210 to filter module 220, from look-up module 210 to generate module 250, from generate module 250 to storage module 225, and the like. The present invention is not limited to this configuration as communication module 230 may also communicate data, such as a user's email address, with any number of other operations running outside of unsolicited email identification and prevention environment 200.

Listening module 240 may be configured to continuously listen to and capture data, such as data associated with a user's email address, which is flowing through, out of, or into unsolicited email identification and prevention environment 200. For example, when a user sends an email via a computer system where the present invention is employed, the email data associated with the sent email will be captured and examined/listened to by listening module 240. An embodiment of the present invention may also be configured so that when listening module 240 captures and/or listens to data, such as email data, that data may be automatically forwarded and/or transferred to look-up module 210 for processing. As discussed above, when that transferred email data is received by look-up module 210, look-up module 210 may analyze that email data and compare that email data, such as the email address, against a stored list of email addresses that are classified as to be governed by the present invention so that look-up module 210 will take the appropriate action for those email addresses that are to be governed by the present invention and for those email addresses that are not to be governed by the present invention. Listening module 240 may also be configured to automatically listen to and capture data associated with a user's email address or it may be configured so that a user will be prompted as to whether or not data associated with a user's email address should be captured.

Generate module 250 operates to generate a new unique email address to be used and substituted in the place of a user's original/direct email address whenever a user divulges his/her email address so that recipients and/or addressees are not given a user's original/direct email address, but will only receive the user's new unique email address created by generate module 250. The new unique email addresses generated by generate module 250 act as channels to the end user. Each unique email address is a channel to the end user that may allow emails to pass through that channel and reach the end user or the channels may be filtered and prevent emails addressed to that specific new unique email address from reaching the end user. The present invention may also include a set or rules, either pre-defined or user specific, that may close the channels and/or shut-off the new unique email addresses which may prevent incoming emails addressed to that specific channel or new unique email address that has been closed from being delivered to the end user.

Unsolicited email identification and prevention environment 200 may also be configured so that when generate module 250 generates a new unique email address to be used in the place of a user's original/direct email address, the original/direct email address and the new unique email address that corresponds to that original/direct email address will be stored in storage module 225 as part of the environment data associated with the email. Thus, the environment data associated with every sent email may be stored in storage module 225, so that unsolicited email identification and prevention environment 200 will be able to match up and connect all new unique email addresses with its corresponding original/direct email addresses and with its corresponding email. Thus, when the present invention receives incoming email, it may allow those incoming emails directed at the new unique email addresses to possibly pass through to the correct end user, depending on filtering for that new unique email address, because all appropriate connections and translations can be made through the information stored in the environment data.

If after analyzing, filtering via filter module 220, and/or monitoring an incoming email that was sent to one of the new unique email addresses or channels, the present invention determines that the incoming email should be filtered out or prevented from reaching the user, then the present invention may close the channel associated with that particular new unique email address so that any emails directed at that new unique email address may not be delivered to the user. A new unique email address that has been shut off and/or the channel closed can also be explained as a super filter in that the filter is filtering out all messages so that no email messages directed to that channel or new unique email address will reach the end user. Thus, emails directed to that “closed” channel or the unique email address that has been shut off or filtered out may reach unsolicited email identification and prevention environment 200 but those incoming emails may never be passed to the end user. Thus, the spammer or sender of the rejected email will likely be notified through its own email system that the particular recipient email address, which is a new unique email addresses generated by the present invention, no longer exists and thus, the spammer will likely stop sending emails to that particular email address as that “channel” or new unique email address was closed. Thus, the new unique email addresses can be closed and/or filtered with absolutely no effect to the user's original/direct email address or account.

In a preferred embodiment, only generate module 250 will generate the new unique email address so that there will be no confusion associated in the generation and identification of new unique email addresses. Generate module 250 will generate a new unique email address when prompted to do so by unsolicited email identification and prevention environment 200. In one embodiment, the present invention may be configured so that after listening module 240 has captured a user's email data and forwarded that data to look-up module 210 and look-up module 210 has analyzed a user's email address and determined that the user's email address is to be analyzed and/or monitored by the present invention, look up module 210 may send a signal to generate module 250 advising generate module 250 to generate a new unique email address to be used in the place of the user's original/direct email address because that particular user is monitored by the present invention. In a preferred embodiment, generate module 250 may generate a new unique email address that will be used in the place of the user's original/direct email address for every new addressee that the user sends email to. The present invention may also be configured so that when generate module 250 generates a new unique email address, data associated with that new unique email address will be stored in storage module 225 as part of the environment data associated with that particular email so that unsolicited email identification and prevention environment 200 will be able to translate and/or connect that new unique email address with other data, such as the user's original email address and the recipient or addressee that this new unique email address is associated with. For example, if a user sends out 5 emails to 5 different addressees or recipients, then generate module 250 may generate 5 new unique email addresses that will be used in the place of the user's original/direct email address so that each of the 5 recipients receives an email that is illustrated as being sent from a different new unique email address. In such an example, storage module may store a set of environment data for each of the 5 emails whereby each set of environment data will include the new unique email addresses and other data associated with the email so that unsolicited email identification and prevention environment 200 will be able to connect and associate the new unique email addresses with the corresponding email and the corresponding recipient.

In one embodiment, unsolicited email identification and prevention environment 200 may be configured so that when incoming email is processed by the present invention, look-up module 210 may analyze the incoming email message and look-up the “To” email address associated with the incoming email message and compare that “To” address against the environment data stored in storage module 225 so that look-up module 210 can make the connection/association between a new unique email address and a corresponding email message and user's original/direct email address. However, the present invention is not limited to this operation as other modules or components other than look-up module 210 may make the connections and associations between a new unique email address and its associated email message and associated original/direct email address.

FIG. 2B illustrates one method of operation of one embodiment of the present invention that is configured as unsolicited email identification and prevention environment 200 of FIG. 2A. In FIG. 2B, the email process begins with a user creating an email through email application 260 whereby the user is identified with an original/direct email address A. Email application 260 may comprise whatever email medium and/or program used by user A to send and/or divulge a user's email address. For example, email application 260 may be Microsoft® Outlook or any number of other email programs. In one embodiment of the present invention, when the user with original/direct email address A sends an email, the user's original/direct email address A may be sent to communication module 230 via link 261 and then sent to listening module 240 via link 234 so that listening module 240 can listen and/or capture email data associated with the email. When listening module 240 determines that an email address is included in the data it is listening to, listening module 240 may then send the email address to look-up module 210 via links 234 and 231. At look-up module 210, look-up module 210 may determine if the email data listened to, such as original/direct email address A is to be monitored by the present invention by searching and/or looking-up any lists of email addresses, that may have been previously identified as email addresses to be monitored by the present invention, stored in storage module 225 via links 231 and 235. If after searching any email lists look-up module 210 determines that original/direct email address A is not monitored by the present invention, then email application 260 may transmit the email message and the user's original/direct email address A straight to recipient 270 via link 262. In this instance, recipient 270 will receive the email message that is identified with the user's original/direct email address A.

If after searching any email lists, look-up module 210 determines that original/direct email address A is to be monitored by the present invention, then look-up module 210 may send a message and/or signal to generate module 250 via communication module 230 and links 231 and 232 directing generate module 250 to generate a new unique email address to be used in the place of original/direct email address A. In generating a new unique email address, generate module 250 may also place/write the newly generated unique email address in the environment data associated with the currently analyzed email and then store that environment data in storage module 225. For example, generate module 250 may generate new unique email address BB, indicated by 251, that will replace the user's original/direct email address A. After generate module 250 has generated new unique email address BB, this data may be written to the environment data associated with the current email and then the environment data stored in storage module 225. Thus, new unique email address BB will replace original/direct email address A and the new unique email address BB and email may then be sent, as indicated by the dotted path 271, to communication module 230 and on to email application 260 and eventually the user's email is sent to recipient 270 whereby recipient 270 will receive the user's email message thinking that the user's email address is BB. However, the present invention is not limited to this configuration as the present invention may be configured so that after new unique email address BB has been generated and has replaced original/direct email address A, the new unique email address BB and email may then be sent from communication module 230 directly to recipient 270 via link 272 without the use of email application 260 whereby recipient 270 will receive the user's email message thinking that the user's email address is BB. The present invention may be configured so that the environment data is not sent with the email to an email recipient or addressee or it may be configured so that all or only a portion of the environment data is sent with the email to an email recipient or addressee.

During this process described in FIG. 2B, listening module 240 is preferably watching all communication, both incoming and outgoing communications. Once email communication occurs, listening module 240 may listen to and/or capture email addresses and upon capturing an email address listening module 240 may trigger look-up module 210 to determine if the particular email communication is governed and/or monitored by the present invention. Listening module 240 basically sits between the user and the recipient and hears the email conversation and begins the process of triggering/notifying unsolicited email identification and prevention environment 200 when it is time to substitute a new unique email address for an original/direct email address.

In an embodiment of the present invention, when recipient 270 decides to communicate with user A from whom it received an email with the new unique email address BB used in the place of original/direct email address A, recipient 270 can create an email and send the email to unique email address BB. In doing so, the email and/or data associated with the email, such as the destination and/or “To” email address coming from recipient 270 may be captured by unsolicited email identification and prevention environment 200 and sent to communication module 230 via link 272. Communication module 230 may then send the email from recipient 270 to listening module 240 via link 234 so that listening module 240 can listen to the email communication for email data, such as a “To” email address and/or an origination and/or “From” email address. Upon listening to and/or capturing an email with a “To” email address, listening module 240 may send that “To” email address to look-up module 210 via communication module 230 and links 234 and 231. Look-up module 210 may then analyze the “To” email address to determine if it is an original/direct email address or a new unique email address by comparing the “To” email address against lists of email addresses and other data stored in storage module 225. If after searching any email lists or other data in storage module 225, look-up module 210 determines that the “To” email address recently analyzed is an original/direct email address and/or an email address not governed by the present invention, then the email will be forwarded to and/or directly sent to the end user with no filtering by the present invention. The present invention may also be configured so that listening module 240 may capture any data associated with an email, such as a “To” email address, an origination/“From” email address, header information, and the like and then send that information to look up module 210 whereby look-up module 210 may compare any of that data against data stored in storage module 225 to then determine how the incoming email should be further processed and/or filtered.

If after searching any email lists or other data in storage module 225, look-up module 210 determines that the “To” email address recently analyzed is a new unique email address that was generated by generate module 250, then look-up module 210 will proceed to search storage module 225 for the environment data and any filtering and/or channeling rules associated with that “To” email address. In one embodiment, the present invention may be configured so that the filtering and/or channeling rules are also stored as part of environment data associated with an email and a new unique email address. In finding the environment data associated with the “To” email address, look-up module 210 can make the connection and/or association between the new unique email address and the original/direct email address as this data may also be located in the environment data. After making this connection between the new unique email address and the original/direct email address and after finding the filtering rules for a particular email and “To” email address, look-up module 210 will forward the email on to filter module 220 via communication module 230 and links 231 and 233.

After the email has been forwarded to filter module 220, filter module 220 will process any and all filtering and/or channeling of the email. After filter module 220 has completed the filtering of the email, the filtered and/or channeled email may be sent to communication module 230 via link 233 for delivery to the end user. Depending on the activity of filter module 220 based on any filtering rules, the incoming email may be forwarded to an end user, passed on directly to an end user, completely filtered out or deleted, partially delivered to an end user, deleted and only select information associated with the incoming email delivered to the user, and the like. A partial delivery may occur in an instance in which an incoming email is filtered but a user has chosen to receive information about the filtered email. For example, a user may configure the present invention to deliver data to the user about the sender of an email message that has been filtered, such as the identity of the sender, the IP address of the sender, the email address of the sender, the domain name associated with the sender, and the like.

In the example illustrated in FIG. 2B, when recipient 270 replies and/or responds to the email, recipient 270 believes that the email came from email address BB and thus recipient 270 is responding to new unique email address BB. When this response/reply email is sent from recipient 270 to user A, the email may be communicated into unsolicited email identification and prevention environment 200 and listening module 240 will hear the email data associated with that incoming email, such as the “To” email address “BB” and the origination email address and have the email or email data forwarded to look-up module 210 to determine if that email is governed by the present invention. Look-up module 210 may then analyze the new unique email address BB and determine that it is an email address generated by generate module 250 and then continue to search for the environment data associated with email address BB and any filtering rules associated with this email. In searching the various data in storage module 225, look-up module 225 will locate the environment data so that it can map and/or identify the incoming email address BB as coming from a specific source so that filter module 220 may then analyze and/or filter the incoming email based on the source or other rules so that the present invention may run filters specific to a source because filters applied by filter module 220 may be per channel or per email source. Filter module 220 will analyze the email from recipient 270 and/or data associated with the email, such as the destination email address, to determine if that email directed at new unique email address BB should be passed on to the user or if it should be filtered out and new unique email address BB closed. As discussed herein, unique email address BB operates as a channel to the end user. If email messages directed at unique email address BB are approved then that channel represented by new unique email address BB will remain open and emails will be delivered to the end user. The present invention may also be configured so that additional checks can be performed on emails after the present invention has monitored an incoming email and approved the incoming email for delivery to the user. However, if email messages directed at unique email address BB are filtered out or rejected, then that channel represented by new unique email address BB to the end user may be completely closed or partially closed so that email messages sent to unique email address BB may be rejected and may not reach the end user. However, the present invention may be configured, depending on the various rules configured by a user, so that some email messages directed at new unique email address BB may be delivered to new unique email address BB, delivered to the end user, such as user A, and some emails directed at unique email address BB will be rejected and will not be delivered to unique email address BB and will not be delivered to user A. If filter module 220 analyzes the email message from recipient 270 directed to new unique email address BB and determines that the email message has passed all filtering rules and/or tests and should be delivered to the user, then the message may be passed on and delivered to the end user, such as user A.

While a common configuration of the present invention may include a client software portion and a server software portion because email is commonly implemented and handled with a server and a client, the present invention is not limited to such configuration. The present invention may also be configured so that the entire software method is installed on one computer or even configured as a combined application where the client and the server are the same machine and/or entity. The invention methodology may also be broken down into several different roles depending on a user's specific needs. For example, the present invention may be configured so that the various portions of the present invention may run on different machines. For example, the filtering process could run on one machine, while the remaining portions run on other machines. The generation portion will preferably be unique to insure that multiple mail servers agree on one new unique email address per email address generation and thus, the generation portion may be broken out into a machine that will server the servers. The software methodology and algorithm may remain the same, but the implementation may be adjusted to fit any number of various hardware scenarios.

The program code segments making up unsolicited email identification and prevention environment 200 can be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, and erasable ROM (EROM), a floppy diskette, a compact disk CD-ROM, an optical disk, a hard disk, a fiber optic medium, a radio frequency (RF) link, etcetera. The computer data signal can propagate over a transmission medium such as electronic network channels, optical fibers, air, electromagnetic, RF links, etcetera. The code segments may be downloaded via computer networks such as the Internet, Intranet, and the like.

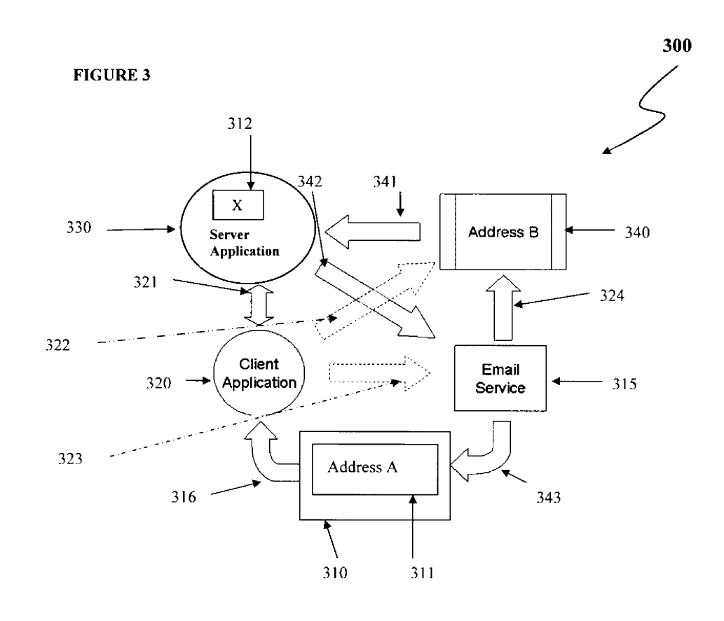

FIG. 3 illustrates a block diagram 300 illustrating one method of operation of the present invention. As illustrated, FIG. 3 includes an email user 310 with an email address A and an email message 311, an email service 315, “To” transmission links 316, 321, 322, 323, and 324, client application 320, server application 330, an email user 340, and “Return” transmission links 341, 342, and 343. Email user 310 may represent a workstation/computer user having an email address of “A.” In the present invention, when email user 310 composes and sends an email message, such as email message 311, that is identified with a “from” email address of “A” that is addressed to a “recipient” email address, such as “recipient” address “B” intended for email user 340, the present invention may be configured so that when email message 311 is sent, it will be transmitted via “To” transmission link 316 to client application 320. The present invention is not limited to email message 311 of FIG. 3 as email message 311 is presented only for illustrative purposes and is not intended as a limitation of the present invention. The present invention may be configured so that when the present invention is operating, an email sent from email user 310, such as email message 311, may be sent over transmission link 316 and directed to client application 320 or the email message 311 may be intercepted by client application 320 before email message 311 is actually sent and delivered to the intended recipient, such as recipient 340 with “recipient” email address “B.”

When client application 320 has intercepted and/or received email message 311 with “from” email address “A” that was composed and sent by email user 310, client application 320 may analyze and process email message 311. Client application 320 may first check email message 311 to determine if email user 310 and email message 311 with address “A” is to be monitored by the present invention. If email user 310 and email message 311 with address “A” is to be monitored and governed by the present invention, then client application may trigger or signal server application 330 to create a new unique email address to replace address “A” associated with email message 311.

Client application 320 may also isolate and store some environment data associated with email message 311. The captured environment data may be stored locally at client application 320 or the environment data may be passed along transmission link 321 to server application 330 where the environment data may be stored at server application 330. An embodiment of the present invention may also be configured so that environment data associated with incoming emails may also be stored at server application 330. The storing of the environment data is advantageous as it allows the present invention to make connections and/or associations between original/direct email addresses and a new unique email address and it may also help the present invention to gather information about a spammer, such as the identity of any recipients that may have leaked/disbursed any new unique email address to spammers. For example, a user having an original/direct email address of “C” that is replaced with new unique email address “DD” sends only one email to “Joe@AOL.com.” In this example, only “Joe@AOL.com” has the new unique email address of “DD.” If user “C” begins to receive spam mail addressed to new unique email address “DD” from a spammer, then it is likely that “Joe@AOL.com” disclosed and/or leaked the new unique email address “DD” to the spammer as only “Joe@AOL.com” was given the new unique email address of “DD.” Thus, the present invention may be configured to gather this data and notify the user that the spammer received the new unique email address “DD” from “Joe@AOL.com” as that was the only user that had new unique email address “DD.”

The present invention may also be configured so that client application 320 may exist at any protocol layer and may interact with user 310. For example, the present invention could be configured so that a user is asked as to whether or not a particular email and email address should be governed by the present invention. In addition, a user may have an embodiment configured to ask a user if the recipient and/or sender of an email is someone that can be trusted. Using any of the layers of the OSI Reference Model of computer network architecture including, but not limited to, the application layer, presentation layer, session layer, transport layer, network layer, data link layer, and the physical layer, client application 320 may read the interaction, such as mail sent for SMTP, and form post for HTTP. Since email addresses can go out at several levels through MANY applications, it is called an interaction, but it is the disclosure of an address via electronic means. An embodiment of the present invention may be configured so that an intercept, such as an intercept of email message 311 and “from” email address “A,” will occur at the application layer so that the present invention may be more efficient than an intercept at a different layer. However, an embodiment of the present invention may also be configured so that, an intercept, such as an intercept of email message 311 and “from” email address “A,” will occur at the network layer so that the present invention is more thorough than an intercept at a different layer. The client application is not limited to any of the 7 OSI model layers or excluded from transgressing the 7 layers. The operation of the present invention is not limited to any of the communication layers. The sending of emails goes through all of the 7 OSI model layers, and the present invention may be configured to operate at any of these 7 layers. One implementation may be to try to catch email communication at the top layer or application layer. In other embodiments, the present invention may be configured to catch email communications at the bottom layer to assure the ability to monitor email communication. The client portion may also interact with various user activities. For example, the client portion of the present invention may interact with a user based on the user's intranet and Internet traffic at a desired protocol communication layer.

After client application 320 has determined that email message 311 with email address “A” is to be governed by the present invention, client application 320 will communicate with server application 330 via “To” transmission link 321. In communicating with server application 330, client application 320 may instruct, notify, and/or signal server application 330 to generate and/or create a new unique email address that will be used in the place of the email address “A” associated with the email message 311 composed by email user 310. For example, in relation to FIG. 3, the present invention may generate a new unique email address “X” that may be used in the place of email address “A” associated with email message 311 composed from email user 310. Thus, email message 311 will now have a “from” email address of “X” instead of its original “from” email address of “A” as illustrated and represented by 312 in server application 330. Thus, in a preferred embodiment, the only difference between original email message 311 and altered email message 312 is that the “from” email addresses are different. In email message 311, the “from” email address is “A” and in altered email message 312, the “from” email address is “X.” The present invention does not alter or change the content or format of the email message. This substitution of a new unique email address in place of the original email address is advantageous as the recipient of the email will not know the real email address of the sender, but will only see the new unique email address that is generated by the present invention. The use of this substitution of a new unique email address will cause future communication and reply to user 310 to be channeled through the new unique email address, such as “X,” in order to reach email user 310 with original address “A.” The utility of the email service is preserved and users can continue to send and receive emails with no problems or interruptions.

In addition, the environment data, which serves as the identity of the intended recipient, associated with the email message, such as the destination information associated with email message 311, may be stored to memory and not replaced or altered by the present invention. Thus, the present invention will not prohibit or jeopardize the delivery of the email message.

After the new unique email address, such as “X,” has been substituted in the place of the original email address, such as “A,” the altered email message, such as altered email message 312, may be delivered to wherever email message 311 was originally going. As illustrated in FIG. 3, altered email message 312, which was originally email message 311, may be delivered to the intended recipient. The present invention may be configured so that the altered email message, such as altered email message 312, is delivered directly to the intended recipient, such as email user 340, via “To” transmission links 321 and 322 or delivered to email service 315 via “To” transmission links 321 and 323 so that email service 315 may then deliver the altered email message directly to the intended recipient, such as email user 340, via “To” transmission link 324.

The altered email message, message 312, may be sent directly from client application 320 to the intended recipient in the instance in which no email service is in use or required or when there is no email application layer for email divulging, such as when a user signs up to some type of Internet service and provides that service with his/her email address as a field on a web-form. Such a scenario requires no email to be sent as it is a complete HTTP process. Embodiments of the present invention may be configured to catch any divulgence by a user of his/her email address. Thus, anytime a user divulges his/her email address whether in actually sending an email through an email service or in providing his/her email through some type of fill-able form on a web page, the present invention can intercept the user's email data, such as email address, and replace the user's email address with a new unique email address so that the intended recipient of the user's email data, such as the user's email address, will not have the actual email address of the user, but will only have the new unique email address. When the altered email message, message 312, is sent to email service 315 via “To” transmission link 323, email service 315 may then deliver the altered email message, message 312, to the intended recipient, email user 340, via “To” transmission link 324. When the altered message is delivered by email service 315, it is delivered just as any other outbound email is delivered. The present invention is also configured so that any recipients of email information, such as a recipient of an actual email through some email service or a recipient of an email or just an email address through some type of web fill-able form, processed by the present invention will be unable to detect the alteration performed by the present invention.

As illustrated in FIG. 3, when email user 340 chooses to communicate back with email user 310, email user 340 only has the new unique email address generated by the present invention, such as email address “X” in altered email message 312. Thus, messages sent from email user 340 to email user 310 will be delivered by email user 340 over “Return” transmission link 341 to server application 330. In some embodiments of the present invention, server application 330 may be part of email service 315. For example, this may exist if the present invention is configured so that server application 330 is a plug-in for email service 315 or when both the server application and email service are implemented and running on the same workstation.

An email or message from email user 340 to email user 310 will not be delivered directly to email user 310, without first being processed by either the client application 320 and/or server application 330 because email user 340 only has the new unique email address, address “X,” that was previously sent with altered email message 312. Thus, emails addressed to the new unique email address, address “X,” will be processed by server application 330 and/or client application 320 before being delivered to email user 310. Server application 330 and/or client application 320 may then analyze the incoming email from email user 340 to determine if this is an acceptable email. This determination is obtained after analyzing any number of pre-established generic rules, scrutiny, or customized rules established by the email user, email user 310. If the present invention determines that the incoming email message, such as an email message from email user 340, is an acceptable email, then that incoming email message that was originally addressed to the new unique email address, address “X,” may be passed on to email service 315 with the original email address “A” via “Return” transmission link 342. Email user 310 will receive email as he/she normally would, after the incoming email message from email user 340 had passed all rules and scrutiny applied to inbound email messages. In a preferred embodiment, future correspondence with email user 340 will continue so that email user 340 will continue to receive email messages from email user 310 that are altered with unique email address “X” instead of original address “A.” Thus, the incoming email message from user 340 has been passed on to email service 315 as an email addressed to the original email address “A” that was originally found at the “from” address in email message 311. After the incoming message has been delivered to email service 315, the incoming email from email user 340 is delivered to email user 310 through normal email means. For example, the email from email user 340 may be forwarded to email user 310.

When an email is sent from email user 340 to email user 310, the email is addressed to unique email address “X” instead of original address “A.” The present invention may be configured so that when the email message coming from email user 340 is sent to server application 330, server application 330 may be configured to analyze data associated with the incoming email, such as any environment data or the “To” email address and then compare that data to other data, such as environment data associated with emails previously sent by email user 310, that may be stored at either server application 330 and/or client application 320. While processing, analyzing and comparing data, the present invention is able to make connections and/or associations between original/direct email addresses, such as address “A,” and a new unique email address, such as new unique email address “X,” so that the incoming email can be delivered to the correct recipient. The delivery and/or forwarding of the email after the connection and/or association is made may include any means of delivery, such as an email forward where server application 330 passes the email to the recipient 310, a new email addressed to the original/direct email address, passing the incoming email on via a modified mail service, or through use of any number of different protocols.

In alternative embodiments, the present invention may be configured so that every time email user 310 communicates with email user 340, original address “A” is replaced with a new unique email address. For example, if email user 310 sent two email messages to email user 340, email user 340 would receive the two messages such that the first message delivered to user 340 may have one new unique email address in the place of address “A” and the second message delivered to user 340 from user 310 may have another new unique email address in place of original address “A.”

If the present invention determines that the incoming email from email user 340 is not an acceptable email, after server application 330 and/or client application 320 has analyzed the incoming email, then no further action occurs and the incoming email that was addressed to the user 310 through the unique email address “X” may never be delivered to user 310. For instance, if somehow the new unique email address “X” that user 340 had knowledge of was given to a spammer, and that spammer sent a spam mail to user 310 through unique email address “X” and the present invention analyzed the spam email and declared the spam email from the spammer to be unacceptable, then that unacceptable email from the spammer may never be delivered to email user 310. Any number of actions can be taken when the present invention declares an email as unacceptable, such as deleting the email, caching the email on a server, blacklisting the email, or the like. The actions may be pre-configured or a user may define the action to take when an email is declared to be unacceptable. For instance, the present invention may pass along information regarding the sender of an unacceptable email to the intended recipient while continuing to delete the actual email.

This handling of email is acceptable for a number of reasons. Unfortunately when your email address is passed out, it often ends up on some type of mailing list that will eventually be the target of spam mail. With the present invention, a user can configure his/her options so that his/her real email address is never divulged, but only new unique email addresses generated by the present invention will be sent out to recipients instead of the true email address. Thus, when a user receives email that has been classified as spam or unacceptable mail, the present invention can shut down or close that particular new unique email address that the unacceptable email was sent to so that the spam email may never be delivered to the user.

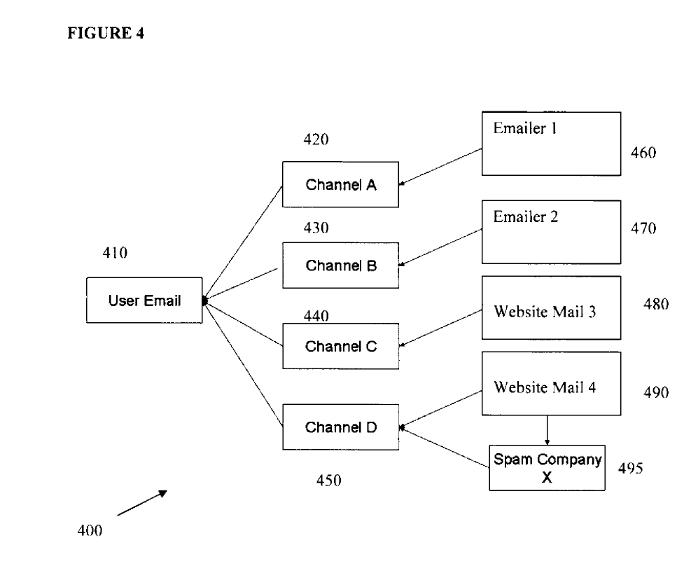

FIG. 4 is a block diagram illustrating a use of the present invention to channel incoming email. Diagram 400 illustrates a user 410 with an email address of “E,” channel A, 420; channel B, 430; channel C, 440; channel D, 450; emailer 1, 460; emailer 2, 470; website mail 3, 480; website mail 4, 490; and Spam company X, 495. In an embodiment of the present invention, user 410 has sent email to four (4) different recipients, illustrated by emailer 1, 460; emailer 2, 470; Website mail 3, 480; and Website mail 4, 490. When user 410 originally sent an email to each of these four recipients, the present invention generated a new unique address that was used in the place of user 410's original/direct email address, “E.” In particular, when user 410 originally sent an email to emailer 1, 460, the present invention replaced email address “E” with address “A” so that emailer 1, 460 would only know user 410's new unique email address “A” instead of the original email address “E.” Likewise, the present invention generated new unique email addresses for the remaining recipients 470, 480, and 490 so that the email sent to emailer 2, 470 was altered so that the original email address “E” was replaced with a unique email address “B,” original email address “E” was replaced with unique email address “C” for email sent to Website mail 3, 480; and original email address “E” was replaced with unique email address “D” for email sent to Website mail 4, 490.

In generating the new unique email addresses A, B, C, and D the present invention basically created a channel for each newly generated unique email address as indicated by channel A, 420; channel B, 430, channel C, 440; and channel D, 450. The creation of the channels by the present invention operates so that incoming email addressed to any of the unique new email addresses previously generated to replace the user's original email address, will have to pass through the respective channels in order to reach the user 410. For example, any email sent from emailer 1, 460 can only pass through channel A, 420 because the only address that emailer 1, 460 has for user 410 is the new unique email address “A.”

Embodiments of the present invention operate to monitor/analyze incoming email based on any number of pre-defined or user specific rules. If the present invention determines that email addressed to a particular new unique email address and channel are unacceptable, then the present invention may close that specific channel so that the unacceptable email is not delivered to user 410. In closing the specific channel, only email addressed to that specific email address and channel will not be delivered and there is no effect on any other emails addressed to other channels and other new unique email addresses. For example, user 410 has been communicating with Website mail 4, 490 so that Website mail 4, 490 believes that the user's email address is “D” instead of original/direct email address “E.” As illustrated in FIG. 4, Website mail 4, 490 has leaked new unique email address “D” to a spam company, such as spam company X, 495. Now that spam company X, 495 has user 410's new unique email address “D” that was originally generated for Website mail 4, 490, spam company X, 495 will begin sending spam mail to user 410. In the present embodiment, the incoming mail from spam company X, 495 is preferably analyzed and the present invention is configured so that it knows that all email addressed to new unique email address “D” and channel D, 450 was previously set up for Website mail 4, 490 and not for any other users. Thus, when the present invention notices that incoming emails from users other than Website mail 4, 490 are addressed to new unique email address “D” and channel D, 450, the present invention recognizes that there is problem. Depending on the configuration by the user and the type of filtering configured by the user, the present invention may automatically close channel D, 450 and shut off new unique email address D, so that any future email directed to channel D will not be delivered. In fact, after channel D is closed and incoming messages are still addressed to channel D, those email messages may be returned to the sender and identified as undeliverable, which may prevent and/or reduce spam. If the present invention and the user close channel D, the user 410 will continue to receive email from all other channels, such as channels A, B, and C.

In one embodiment of the present invention, when an incoming email is classified and/or characterized as unauthorized, the present invention can gather information about that incoming email and then deliver that information to the user 410. For example, under the scenario of FIG. 4, the present invention may be configured so that when an incoming mail from spam company X 495 is received at channel D, information about that spam mail, such as the sender's email address and the identity of the party who leaked the new unique email address to the spam company can be captured and sent to user 410. In such a scenario, the present invention may be configured to notify user 410 that the sender of the spam is spam company X, 495, and spam company X, 495 obtained the new unique email address “D” from Website mail 4, 490.

While the present invention can be configured to shut off an entire channel, the present invention may also be configured to filter Channel D, via other means, such as modern day spam filters, so that user 410 may still receive email from Website mail 4, 490.

In one embodiment, the present invention may be configured to generate a new unique email address upon demand. The embodiments described above explain the present invention when a user is actually sending an email or somehow divulging and/or disclosing his/her email address from a computer or workstation where the present invention is operating. However, the present invention may also be configured to assist a user in various situations where the user is not using his/her workstation or other device where the present invention is installed but the user does not want to disclose his/her original/direct email address. For example, a user of the present invention may be in a situation where the user wishes and/or is required to divulge an email address to another party in any number of situations, such as over the telephone, during a face-to-face conversation, at a meeting, via some non-electronic written means, or at some location other than the user's computer, and the like, but the user does not want to hand out his/her original/direct email address. Thus, an embodiment of the present invention may be configured to generate a new unique email address at the request of the user so that the user may then use this new unique email address as an email address to hand out to other parties when the user does not want to disclose his original/direct email address. In such an embodiment, a user may generate a new unique email address by activating some type of command or trigger that will cause the present embodiment to generate a new unique email address and display and/or disclose this new unique email address to the user so that the user may then use this new unique email address as a handout email address to disclose to third parties. For instance, the user may activate an embodiment of the present invention to generate a new unique email address that the user can write down and take with him and/or remember so that the user can later hand out to third parties. In addition, the present embodiment may be configured to run on any number of electronic devices, such as personal digital assistants, cellular telephones, email devices, and the like so that a user may generate a new unique email address upon demand. For example, with the present invention installed on a cellular telephone, when a user needs to disclose an email address and the user does not want to disclose his/her original/direct email address, the user can activate the present invention to generate a new unique email address by triggering and/or pressing a button on his cellular phone so that the user will instantly have a new unique email address that the user can then disclose to various third parties.

The present invention may also be configured to store the newly generated email address and any other data associated with the new unique email address so that this data may be retrieved for additional processing so that the present invention may keep track of any recipients of the newly generated email address. Preferably, the user would only hand this new unique email address out to one third party so that the present embodiment can keep track of the identity of the recipient that is associated with this new unique email address. However, the present invention is not limited to such use, as a user may be in a situation where the user is required to hand out this newly generated email address to multiple third parties at or about the same time. For example, the user may be attending some type of conference where the user is required to disclose his/her email address to a list that is circulated to multiple third parties. Thus, the newly generated email address would be disclosed to multiple third parties. The present invention may be configured so that when multiple emails are directed at and/or received by the user at the one new unique email address previously disclosed on the email list, the present invention will store the incoming “from” email addresses and when and/or if the user responds to these multiple emails, the present invention will generate another new unique email address for each addressee that the user responds to so that the present invention may then filter and/or monitor the email communications between the user and each addressee separately with a separate channel.

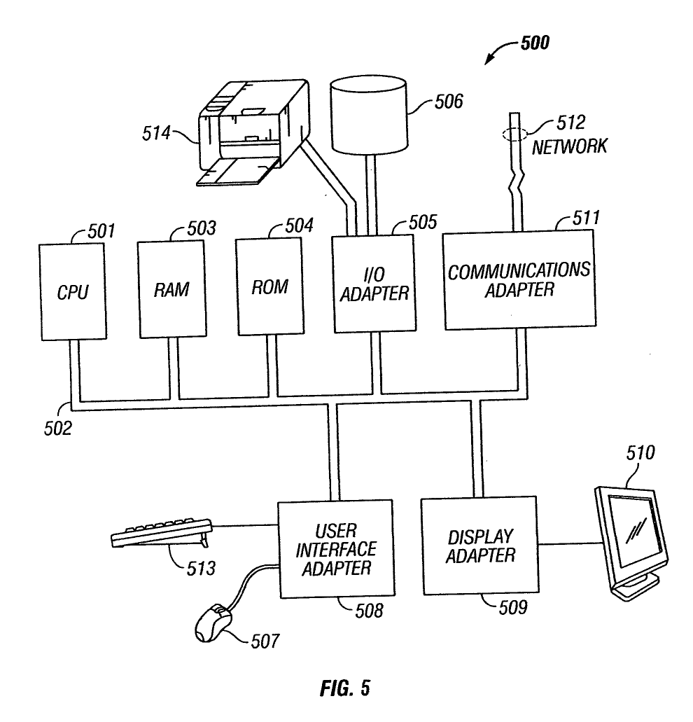

FIG. 5 illustrates computer system 500 adapted to use embodiments of the present invention, e.g. storing and/or executing software associated with the embodiments. Central processing unit (CPU) 501 is coupled to system bus 502. The CPU 501 may be any general purpose CPU. However, embodiments of the present invention are not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Bus 502 is also coupled to input/output (I/O) controller card 505, communications adapter card 511, user interface card 508 and display card 509. The I/O adapter card 505 connects storage devices 506, such as one or more of a hard drive, a CD drive, a floppy disk drive, a tape drive, to computer system 500. The I/O adapter 505 is also connected to printer 514, which would allow the system to print paper copies of information such as documents, photographs, articles, etcetera. Note that the printer may be a printer (e.g. dot matrix, laser, etcetera.), a fax machine, scanner, or a copier machine. Communications card 511 is adapted to couple the computer system 500 to a network 512, which may be one or more of a telephone network, a local (LAN) and/or a wide-area (WAN) network, an Ethernet network, and/or the Internet network. User interface card 508 couples user input devices, such as keyboard 513, pointing device 507, etcetera to the computer system 500. The display card 509 is driven by CPU 501 to control the display on display device 510.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for avoiding unsolicited email comprising:
examining an original email address that is associated with an email user;
generating a new unique email address; and
replacing said original email address with said new unique email address.

2. The method of claim 1 further comprising
storing said new unique email address to memory.

3. The method of claim 1 wherein said examining an original email address that is associated with an email user comprises:
analyzing said original email address to determine if said original email address has been classified for further processing;
marking said analyzed original email address if said original email address has been classified for further processing.

4. The method of claim 3 wherein said generating new unique email address comprises:
creating a new unique email address;
creating a unique channel associated with said new unique email address wherein said unique channel is a pathway for email communications directed at said new unique email address to reach said email user.

5. The method of claim 4 further comprising:
filtering incoming email communications.

6. The method of claim 5 wherein said filtering said incoming email communications comprises one or more of:
filtering incoming email communications by IP address;
filtering incoming email communications by destination email address;
filtering incoming email communications by content; and
filtering incoming email communications by domain name.

7. The method of claim 5 further comprising:
altering said unique channel associated with said new unique email address in response to said filtering.

8. The method of claim 7 wherein said altering said unique channel comprises one or more of:
closing said unique channel in response to said filtering of incoming email communications so that no further email communications directed at said unique channel will reach said user;
restricting said unique channel in response to said filtering of incoming email communications so that only certain email communications directed at said unique channel will reach said user.

9. The method of claim 5 further comprising:
processing said incoming email communications in response to said filtering.

10. The method of claim 9 wherein said processing said incoming email communications in response to said filtering comprises one or more of:
delivering said incoming email communications to said user via said unique channel;
deleting said incoming email communications;
delivering only a portion of data associated with said incoming email communications to said user;
generating a reply email in response to said incoming email communications; and
forwarding said incoming email communication to a location other than said email user.

11. A computer program product having computer readable medium with computer program logic recorded thereon for preventing unsolicited email, said computer program product comprising:
code for analyzing original email addresses;
code for marking said original email addresses;
code for generating new unique email addresses;
code for replacing said marked original email addresses with said new unique email addresses.

12. The computer program product of claim 11 further comprising:
code for communicating.

13. The computer program product of claim 12 wherein said code for generating new unique email addresses comprises:
code for creating new unique email addresses; and
code for generating a new unique channel for every newly created unique email address.

14. The computer program product of claim 13 further comprising:
code for storing data associated with said new unique email addresses to memory.

15. The computer program product of claim 14 further comprising:
code for filtering incoming email communications.

16. The computer program product of claim 15 wherein said code for filtering incoming email communications comprises one or more of:
code for creating user specific filtering rules;
code for applying pre-configured rules;
code for filtering based on email content;
code for filtering based on IP address; and
code for filtering based on domain identity.

17. The computer program product of claim 15 further comprising:
code for isolating data associated with said incoming email communications; and
code for displaying said isolated data.

18. The computer program product of claim 17 wherein said code for creating new unique email addresses comprises:
code for creating new unique email addresses upon demand in response to a signal.

19. The computer program product of claim 18 wherein said signal may comprise one or more of:
a signal generated from a personal digital assistant;
a signal generated from a cellular telephone;
a signal generated from a pager; and
a signal generated from a computer workstation.

20. A system for preventing spam email comprising:
a means for identifying email accounts having original/direct email addresses that are to be protected from said spam email;
a means for monitoring email communications;
a means for generating a new unique email address;
a means for generating a specific channel associated with said generated new unique email address whereby said specific channel provides a pathway to said email account having said original/direct email address;
a means for replacing said original/direct email addresses of said identified email accounts with said new unique email addresses;
a means for storing data associated with said new unique email addresses to memory;
a means for filtering incoming email communications addressed at said new unique email addresses;
a means for gathering data associated with a sender of email communications directed at said new unique email addresses;
a means for displaying said gathered data;
a means for processing delivery of email communications after said email communications have been filtered; and
a means for altering said specific channel in response to said filtering.
